(19) United States
(12) Patent Application Publication
(10) Pub. No.: US 2025/0229413 A1
(43) Pub. Date: Jul. 17, 2025

(54) ROBOT

(71) Applicant: Panasonic Intellectual Property Management Co., Ltd., Osaka (JP)

(72) Inventor: Yoshiki Matsumoto, Osaka (JP)

(21) Appl. No.: 19/098,321

(22) Filed: Apr. 2, 2025

Related U.S. Application Data
(63) Continuation of application No. PCT/JP2023/036272, filed on Oct. 4, 2023.

(30) Foreign Application Priority Data
Oct. 6, 2022 (JP) 2022-161940

(51) Int. Cl. B25J 5/00; B25J 19/00

(52) U.S. Cl. CPC B25J 5/007; B25J 19/0004

(57) ABSTRACT

A robot includes a main body and a cart that includes a wheel and is capable of coupling to the main body. The main body includes an insertion that is inserted into the cart when the main body is in a coupled state with the cart. The cart includes a brake mechanism that switches between a brake state in which a brake is applied to the wheel and a free state in which the brake is not applied to the wheel. In the brake mechanism, during the coupled state, the free state is maintained by the insertion, and when the coupled state is released and the insertion is removed from the cart, the free state is switched to the brake state.

### TECHNICAL FIELD

The present disclosure relates to a robot.

### BACKGROUND ART

Conventionally, a robot including a main body capable of traveling and a cart having wheels is known (see, Patent Literature (hereinafter, referred to as PTL) 1). The cart is connectable to the main body. In a state in which the main body and the cart are coupled to each other (hereinafter, referred to as a coupled state), the main body is capable of pulling the cart.

### CITATION LIST

### Patent Literature

### PTL 1

Japanese Patent Application Laid-Open No. 2019-148871

### SUMMARY OF INVENTION

### Technical Problem

PTL 1 described above does not disclose a brake of the cart in conjunction with a coupled state with at least the main body. For this reason, for example, in a state in which the coupled state between the main body and the cart is released, there is a possibility that the cart may move.

An object of the present disclosure is to provide a robot capable of applying or releasing a brake to or from a cart in conjunction with a coupled state between a main body and the cart.

### Solution to Problem

An aspect of a robot according to the present disclosure includes:
a main body; and
a cart that includes a wheel and is capable of coupling to the main body,
in which
the main body includes an insertion that is inserted into the cart when the main body is in a coupled state with the cart,
the cart includes a brake mechanism that switches between a brake state in which a brake is applied to the wheel and a free state in which the brake is not applied to the wheel, and
in the brake mechanism,
   during the coupled state, the free state is maintained by the insertion, and
   when the coupled state is released and the insertion is removed from the cart, the free state is switched to the brake state.

### Advantageous Effects of Invention

The present disclosure can provide a robot capable of applying a brake to a cart in a state where coupling between a main body and the cart is released.

### BRIEF DESCRIPTION OF DRAWINGS

FIG. 1 is a perspective view of a robot according to an embodiment of the present disclosure;

FIG. 2 is another perspective view of the robot according to the embodiment of the present disclosure;

FIG. 3 is a schematic diagram illustrating the configuration of the robot according to the embodiment of the present disclosure;

FIG. 4 is a side view of a wheel;

FIG. 5 illustrates the configuration of a brake mechanism;

FIG. 6 illustrates a behavior of the brake mechanism when the brake mechanism transitions to a brake state based on an operation input of a user;

FIG. 7 illustrates the behavior of the brake mechanism when the brake mechanism transitions to the brake state based on the operation input of the user;

FIG. 8 illustrates the behavior of the brake mechanism when the brake mechanism transitions to the brake state based on the operation input of the user;

FIG. 9 illustrates the behavior of the brake mechanism when the brake mechanism transitions to a free state based on the operation input of the user;

FIG. 10 illustrates the behavior of the brake mechanism when the brake mechanism transitions to the free state based on the operation input of the user;

FIG. 11 illustrates the behavior of the brake mechanism when the brake mechanism transitions to the free state based on the operation input of the user;

FIG. 12 illustrates the behavior of the brake mechanism when the main body and the cart are coupled to each other;

FIG. 13 is a perspective view illustrating the behavior of the brake mechanism when the main body and the cart are coupled to each other;

FIG. 14 illustrates the behavior of the brake mechanism when the main body and the cart are coupled to each other;

FIG. 15 illustrates the behavior of the brake mechanism when the main body and the cart are coupled to each other;

FIG. 16 is a perspective view illustrating a state in which the coupling between the cart and the main body is released;

FIG. 17 illustrates the behavior of the brake mechanism when an insertion is removed from the brake mechanism; and

FIG. 18 illustrates the behavior of the brake mechanism when the insertion is removed from the brake mechanism.

### DESCRIPTION OF EMBODIMENTS

Hereinafter, embodiments of the present disclosure will be described in detail with reference to the drawings.

### Embodiment

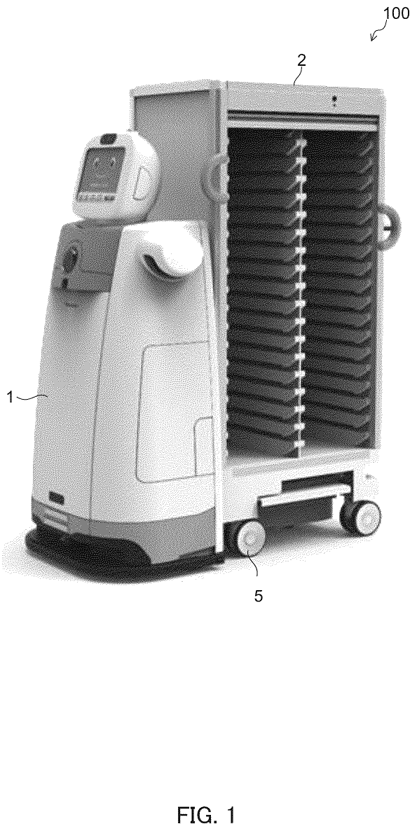

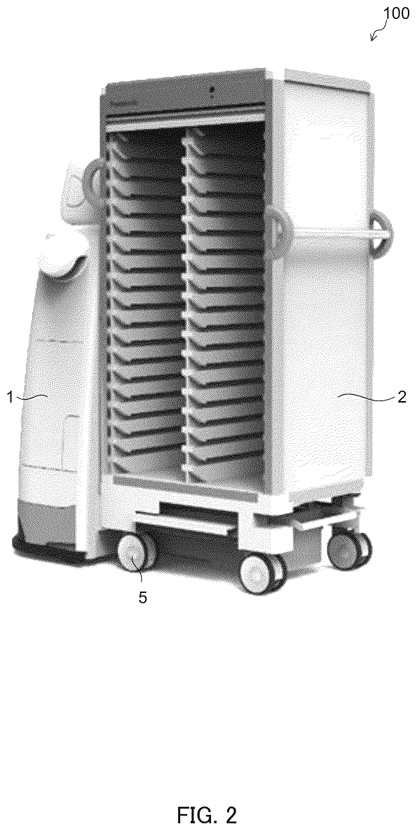

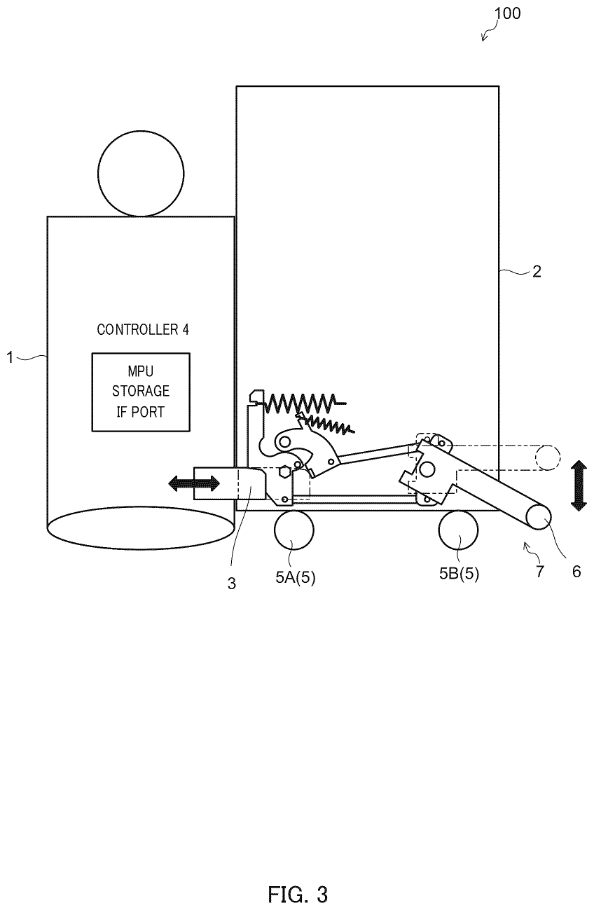

FIG. 1 is a perspective view of robot 100 according to the present embodiment. FIG. 2 is another perspective view of robot 100. FIG. 3 illustrates the configuration of robot 100.

As illustrated in FIGS. 1 to 3, robot 100 includes main body 1 and cart 2. Robot 100, for example, autonomously travels within a hospital and transports drugs from a pharmacy to one or more destinations at once. Robot 100 may be configured to travel by remote control, for example. Hereinafter, a description will be given of robot 100 that autonomously travels within a hospital as one aspect of the expected embodiment, but the present disclosure is not limited thereto and can be widely applied to a robot that performs transportation regardless of whether the robot is inside or outside a facility.

### <Main Body 1>

First, an outline of robot 100 will be described. Main body 1 transports drugs loaded on cart 2 at once and autonomously travels from the pharmacy to destination. Main body 1 stops when it reaches the destination.

Then, upon arriving at any set destination, the coupled state between main body 1 and cart 2 (i.e., a state in which main body 1 and cart 2 are coupled with each other) is automatically released. The automatic release of the coupled state will be described below. Further, a nurse may pull cart 2 from main body 1 to release the coupling between main body 1 and cart 2. In the case of robot 100 according to the present embodiment, when the coupling between main body 1 and cart 2 is released, a brake is automatically applied to wheel 5 of cart 2. For this reason, it is possible to prevent cart 2 from moving in a state where the coupling between main body 1 and cart 2 is released.

Subsequently, the nurse dispenses the drugs and returns cart 2 to the pharmacy. Alternatively, cart 2 may be transported to the pharmacy by robot 100, which has been pulling cart 2, or another robot 100. On the other hand, main body 1, from which the coupling with the cart has been released, autonomously returns to the pharmacy alone. Then, a pharmacist loads drugs onto another cart 2 and connects this cart 2 to main body 1. Hereinafter, a specific configuration of robot 100 will be described.

Main body 1 is a movable body configured to travel. Main N body 1 includes insertion 3 that is inserted into cart 2 when the main body is in a coupled state with cart 2. Insertion 3 is inserted into and removed from cart 2. Insertion 3 is composed of a pair of left and right sides block-shaped members provided at the rear of cart 2.

Specifically, insertion 3 is a substantially rectangular parallelepiped with its longitudinal direction coinciding with the front-rear direction. Insertion 3 extends rearward from the rear of cart 2. Note that, only the left-side insertion 3 is illustrated in FIG. 3. Further, the shape of insertion 3 is not limited to the illustrated shape.

The left-side insertion 3 corresponds to the left-side brake mechanism 7 of brake mechanism 7 described below. On the other hand, the right-side insertion (not illustrated) corresponds to the right-side brake mechanism (not illustrated) of brake mechanism 7.

In the present disclosure, the left-right direction coincides with the width direction of robot 100 unless otherwise specified. The left direction coincides with the left side when viewed from the rear to the front of robot 100. The right direction coincides with the right side when viewed from the rear to the front of robot 100.

Main body 1 includes controller 4. Controller 4 is composed of a micro processing unit (MPU), a storage, an interface (IF) port, and the like. Controller 4 performs overall control of the behavior of main body 1.

### <Cart 2>

Cart 2 includes wheels 5, lever 6 as an operation input, and brake mechanism 7.

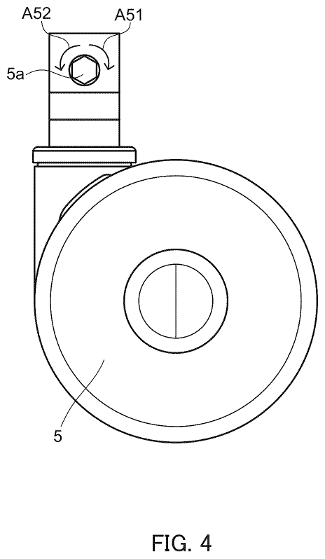

Wheels 5 include a pair of left and right front wheels 5A and a pair of left and right rear wheels 5B. FIG. 4 is a side view of front wheel 5A. Front wheel 5A is configured to be switchable between a brake state (also referred to as the brake state of front wheel 5A) in which a braking force is applied to front wheel 5A and a free state (also referred to as the free state of front wheel 5A) in which no braking force is applied to front wheel 5A.

The brake state of front wheel 5A corresponds to the brake state of wheel 5. The free state of front wheel 5A corresponds to the free state of wheel 5. Note that, the pair of rear wheels 5B may be wheels in a free state at all times.

In the free state of wheel 5, cart 2 is movable. In the brake state of wheel 5, cart 2 is not movable.

As illustrated in FIG. 4, front wheel 5A includes hexagonal portion 5a on the axle thereof. Hexagonal portion 5a corresponds to an example of a to-be operated part of the wheel. When hexagonal portion 5a turns in a predetermined direction, the free state and the brake state of front wheel 5A are switched. Hexagonal portion 5a is connected to brake mechanism 7 (specifically, wheel-interlock 8) described below.

When hexagonal portion 5a rotates in the first rotation direction (the direction indicated by arrow A51 in FIG. 4) by a predetermined angle (for example, 30 degrees), front wheel 5A enters the brake state from the free state.

Further, when hexagonal portion 5a rotates in the second rotation direction (the direction indicated by arrow A52 in FIG. 4) by a predetermined angle (for example, 30 degrees), front wheel 5A enters the free state from the brake state. The torque required for the operation of hexagonal portion 5a is, for example, 5.0 N·m.

In the present disclosure, for convenience of description, a direction in which a component of robot 100 turns when a brake is applied to wheel 5 (specifically, front wheel 5A) is referred to as the first rotation direction. For convenience of description, a direction in which a component of robot 100 turns when the brake of wheel 5 is released is referred to as the second rotation direction. The first rotation direction and the second rotation direction are set for each component of robot 100. The first rotation direction and the second rotation direction may differ for each component of robot 100, or they may coincide.

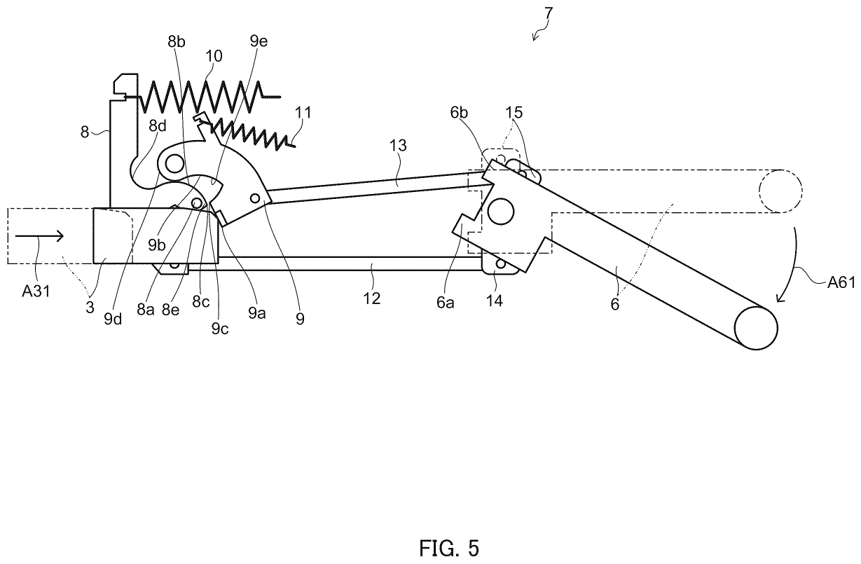

Lever 6 is a foot lever that a user inputs with their foot. After the user operates lever 6 with their foot to release the brake on wheel 5, they push cart 2. Lever 6 can be switched between a brake position (a position of lever 6 indicated by a solid line in FIG. 5) corresponding to the brake state of wheel 5 and a free position (a position of lever 6 indicated by a two-dot chain line in FIG. 5) corresponding to the free state of wheel 5 based on an input of the user to push down or push up.

As illustrated in FIG. 5, lever 6 is connected to brake mechanism 7 described below at the front end of the lever. Specifically, lever 6 is connected to the left-side brake mechanism and the right-side brake mechanism that constitute brake mechanism 7. FIG. 5 illustrates only the connection mode between lever 6 and the left-side brake mechanism that constitutes brake mechanism 7.

Lever 6 includes one end (in the present embodiment, the rear end) into which the user inputs the operation force, and the other end (in the present embodiment, the front end) which is an end on the side opposite to the one end. Lever 6 includes first claw 6a and second claw 6b at each of the left end and the right end in the front end.

FIG. 5 illustrates a configuration of brake mechanism 7. Brake mechanism 7 includes wheel-interlock 8, stopper 9, first biasing member 10, second biasing member 11, first link 12, second link 13, first plate 14, and second plate 15.

Brake mechanism 7 can apply a brake to wheel 5 based on an input from the user. Further, brake mechanism 7 can apply a brake to wheel 5 based on the movement of insertion 3 (specifically, the removal of insertion 3 from brake mechanism 7) described below.

Brake mechanism 7 switches between a brake state (also referred to as the brake state of brake mechanism 7) in which a brake is applied to wheel 5 and a free state (also referred to as the free state of brake mechanism 7) in which no brake is applied to wheel 5.

In the present embodiment, brake mechanism 7 is provided on each of the pair of front wheels 5A of wheels 5. That is, brake mechanism 7 includes a left-side brake mechanism corresponding to a left-side front wheel 5A and a right-side brake mechanism corresponding to a right-side front wheel 5A.

For example, only the left-side brake mechanism of brake mechanism 7 is illustrated in FIG. 5 and the like. The configuration of the right-side brake mechanism is substantially the same as the configuration of the left-side brake mechanism. The left-side brake mechanism and the right-side brake mechanism move in conjunction with each other via lever 6.

During the coupled state between main body 1 and cart 2, brake mechanism 7 maintains the free state based on the engagement with insertion 3. At this time, lever 6 is positioned at the free position.

In brake mechanism 7, when the coupled state between main body 1 and cart 2 is released and insertion 3 is removed from cart 2, the posture of brake mechanism 7 is changed and the free state is switched to the brake state. At this time, brake mechanism 7 moves lever 6 from the free position to the brake position.

Further, brake mechanism 7 is capable of switching between a brake state and a free state based on an input from the user. Specifically, brake mechanism 7 is capable of switching between the brake state and the free state based on an input from the user's foot to lever 6.

It should be noted that, during the coupled state between main body 1 and cart 2, brake mechanism 7 maintains the free state of brake mechanism 7 regardless of the input from the user to lever 6. In other words, during the coupled state between main body 1 and cart 2, lever 6 does not switch the state of brake mechanism 7 between the brake state and the free state even when an input is received from the user.

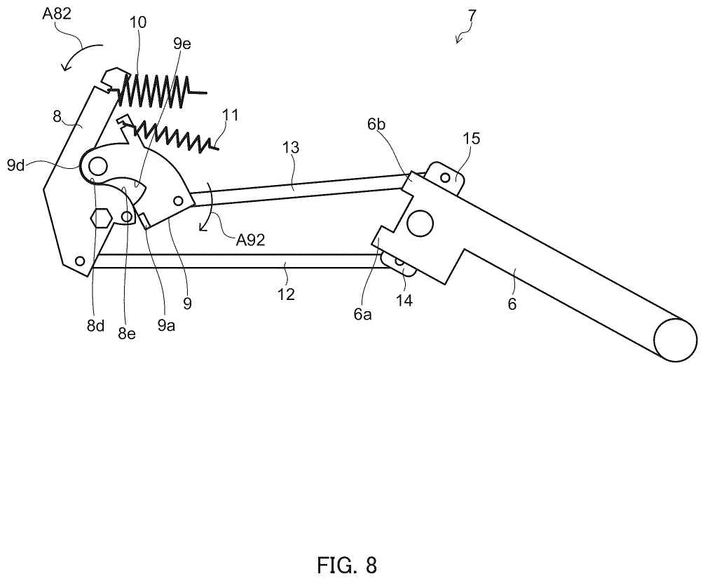

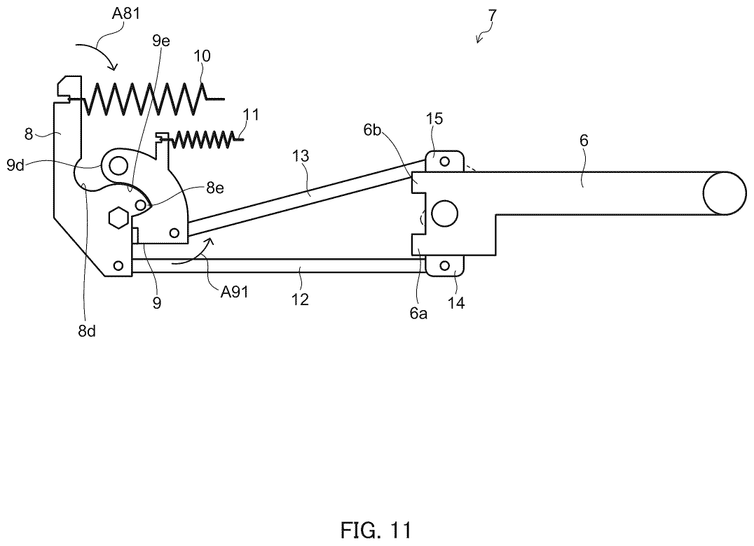

Wheel-interlock 8 is connected to wheel 5 (specifically, hexagonal portion 5a of wheel 5). Wheel-interlock 8 is turnable in a predetermined direction. Specifically, wheel-interlock 8 turns in the first rotation direction (the direction indicated by arrow A81 in FIG. 11) when brake mechanism 7 transitions from the free state (see FIG. 11) to the brake state (see FIG. 8).

Hereinafter, the behavior of brake mechanism 7 when the brake mechanism transitions from the free state to the brake state may also be referred to as the braking behavior of brake mechanism 7. In the braking behavior, wheel-interlock 8 turns by a predetermined angle (for example, 30 degrees). Wheel-interlock 8 is constantly biased in the first rotation direction by first biasing member 10 described below.

On the other hand, wheel-interlock 8 turns in the second rotation direction (the direction indicated by arrow A82 in FIG. 8) when brake mechanism 7 transitions from the brake state (see FIG. 8) to the free state (see FIG. 11). While wheel-interlock 8 turns in the second rotation direction, wheel-interlock 8 rotates against the biasing force of first biasing member 10.

Hereinafter, the behavior of brake mechanism 7 when the brake mechanism transitions from the brake state to the free state may also be referred to as the brake releasing behavior of brake mechanism 7. In the brake releasing behavior, wheel-interlock 8 turns by a predetermined angle (for example, 30 degrees).

Wheel-interlock 8 is interlocked with wheel 5. Wheel-interlock 8 includes contact part 8a that contacts side 3a of insertion 3 during the coupled state between main body 1 and cart 2.

Wheel-interlock 8 includes first tapering part 8c at first outer edge 8b. First outer edge 8b refers to a part that is located at the outer edge of wheel-interlock 8 and that can face second outer edge 9b of stopper 9 described below.

Wheel-interlock 8 includes first recess 8d at first outer edge 8b. First recess 8d is a part that is engageable with first protrusion 9d of stopper 9 described below in the brake state of brake mechanism 7 (see FIG. 8).

In a state where first recess 8d and first protrusion 9d are engaged with each other, the turning of wheel-interlock 8 is restricted by stopper 9. That is, in a state in which first recess 8d and first protrusion 9d are engaged with each other, the posture (specifically, the turned posture) of wheel-interlock 8 illustrated in FIG. 8 is maintained. The turned posture of wheel-interlock 8 corresponds to an example of the second posture of wheel-interlock 8.

Further, wheel-interlock 8 includes second protrusion 8e at first outer edge 8b. Second protrusion 8e is a part that is engageable with second recess 9e of stopper 9 in the free state of brake mechanism 7 (see FIG. 11).

In a state where second protrusion 8e and second recess 9e are engaged with each other, the turning of wheel-interlock 8 is restricted by stopper 9. That is, in a state where second protrusion 8e and second recess 9e are engaged with each other, the posture (specifically, the reference posture) of wheel-interlock 8 illustrated in FIG. 11 is maintained. The reference posture of wheel-interlock 8 corresponds to an example of the first posture of wheel-interlock 8.

Stopper 9 is turnable in a predetermined direction. Specifically, stopper 9 turns in the first rotation direction (the direction indicated by arrow A91 in FIG. 11) during the braking behavior of brake mechanism 7. Stopper 9 turns by a predetermined angle in the braking behavior of brake mechanism 7. While stopper 9 turns in the first rotation direction, it turns against the biasing force of second biasing member 11 described below.

On the other hand, stopper 9 turns in the second rotation direction (the direction indicated by arrow A92 in FIG. 8) based on the biasing force of second biasing member 11 in the brake releasing behavior of brake mechanism 7. In the brake releasing behavior of brake mechanism 7, stopper 9 turns by a predetermined angle. Stopper 9 is constantly biased in the second rotation direction by second biasing member 11 described below.

Stopper 9 turns along first outer edge 8b of wheel-interlock 8 around the turning center during the above-described turning. Stopper 9 includes abutting part 9a that contacts insertion 3 during the coupled state between main body 1 and cart 2.

During the coupling of main body 1 and cart 2 to each other, insertion 3 abuts against abutting part 9a when insertion 3 is inserted into brake mechanism 7. The behavior of brake mechanism 7 when main body 1 and cart 2 are connected will be described below.

Stopper 9 includes second tapering part 9c at second outer edge 9b. Second outer edge 9b refers to a part that is located at the outer edge of stopper 9 and that can face first outer edge 8b of wheel-interlock 8.

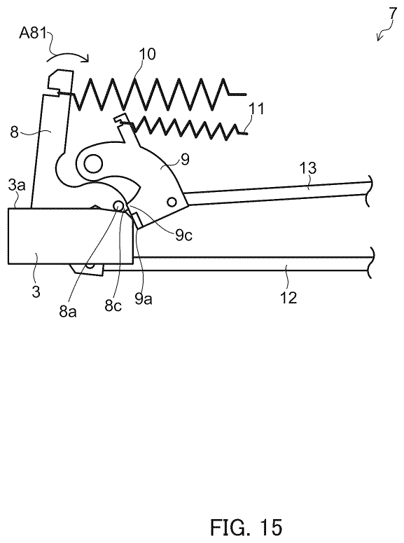

First tapering part 8c of wheel-interlock 8 and second tapering part 9c of stopper 9 face each other in the front-rear direction in a state where insertion 3 is inserted into brake mechanism 7 (see FIG. 15). Stopper 9 includes first protrusion 9d at second outer edge 9b. First protrusion 9d corresponds to an example of the first engaging part, and is a part that is engageable with first recess 8d of wheel-interlock 8 in the brake state of brake mechanism 7.

In a state where first protrusion 9d and first recess 8d are engaged with each other, stopper 9 restricts the turning of wheel-interlock 8. That is, in a state where first protrusion 9d and first recess 8d are engaged, stopper 9 maintains the posture (specifically, the turned posture) of wheel-interlock 8 illustrated in FIG. 8. In other words, in a state where first protrusion 9d and first recess 8d are engaged, stopper 9 maintains the state of brake mechanism 7 (specifically, the brake state) as illustrated in FIG. 8.

Further, stopper 9 includes second recess 9e at second outer edge 9b. Second recess 9e corresponds to an example of the second engaging part, and is a part that is engageable with second protrusion 8e of wheel-interlock 8 in the free state of brake mechanism 7 (see FIG. 11).

In a state where second recess 9e and second protrusion 8e are engaged with each other, stopper 9 restricts the turning of wheel-interlock 8. That is, in a state where second recess 9e and second protrusion 8e are engaged with each other, stopper 9 maintains the posture (specifically, the reference posture) of wheel-interlock 8 illustrated in FIG. 11. In other words, in a state where second recess 9e and second protrusion 8e are engaged, stopper 9 maintains the state of brake mechanism 7 (specifically, the free state) illustrated in FIG. 11.

Here, a state in which wheel-interlock 8 and stopper 9 are engaged with each other according to the state of brake mechanism 7 will be summarized.

First, in the brake state of brake mechanism 7 (see FIG. 8), first recess 8d of wheel-interlock 8 and first protrusion 9d of stopper 9 engage with each other. In the brake state of brake mechanism 7 (see FIG. 8), second protrusion 8e of wheel-interlock 8 and second recess 9e of stopper 9 do not engage with each other (in other words, are separated from each other). The posture of stopper 9 in a state in which first recess 8d of wheel-interlock 8 and first protrusion 9d of stopper 9 are engaged with each other is referred to as a second regulation posture.

Further, in the free state of brake mechanism 7 (see FIG. 11), second protrusion 8e of wheel-interlock 8 and second recess 9e of stopper 9 engage with each other. In the free state of brake mechanism 7 (see FIG. 11), first recess 8d of wheel-interlock 8 and first protrusion 9d of stopper 9 do not engage with each other (in other words, are separated from each other). The posture of stopper 9 in a state in which second protrusion 8e of wheel-interlock 8 and second recess 9e of stopper 9 are engaged with each other is referred to as a first regulation posture.

As described above, stopper 9 switches, based on its own turning, between a state in which the free state of brake mechanism 7 is maintained and a state in which the brake state of brake mechanism 7 is maintained. In other words, stopper 9 is configured to restrict the turning of wheel-interlock 8 based on the disposition relationship between the stopper and wheel-interlock 8. As described above, in the present embodiment, it is possible to achieve a configuration that maintains the state of brake mechanism 7 with a small number of components. Thus, according to the present embodiment, it is possible to reduce the manufacturing cost.

First biasing member 10 is, for example, a coil spring, and changes the posture of wheel-interlock 8. One end (front end) of first biasing member 10 is connected to wheel-interlock 8. On the other hand, the other end (rear end) of first biasing member 10 is connected to a fixed portion (not illustrated) fixed to the housing of cart 2, for example.

First biasing member 10 constantly biases wheel-interlock 8. The direction in which first biasing member 10 biases wheel-interlock 8 is a direction in which wheel-interlock 8 is turned in the first rotation direction (the direction indicated by arrow A81 in FIG. 11).

Second biasing member 11 biases stopper 9 in a direction (specifically, rearward) that moves stopper 9 away from wheel-interlock 8. In other words, second biasing member 11 constantly biases stopper 9. The direction in which second biasing member 11 biases stopper 9 is a direction in which stopper 9 is turned in the second rotation direction (the direction indicated by arrow A92 in FIG. 8).

First link 12 is a rod-shaped member that extends in the front-rear direction. One end (front end) of first link 12 is connected to wheel-interlock 8 in a turnable manner. The other end (rear end) of first link 12 is connected to first plate 14 in a turnable manner.

Second link 13 is a rod-shaped member that extends in the front-rear direction. One end (front end) of second link 13 is connected to stopper 9 in a turnable manner. The other end (rear end) of second link 13 is connected to second plate 15 in a turnable manner.

First plate 14 and second plate 15 turn around the same turning center at the other end of lever 6. The first link 12 side of first plate 14 is engaged with first claw 6a. The second link 13 side of second plate 15 is engaged with second claw 6b of lever 6.

<Behavior for Applying Brake to Wheel based on Operation Input from User>

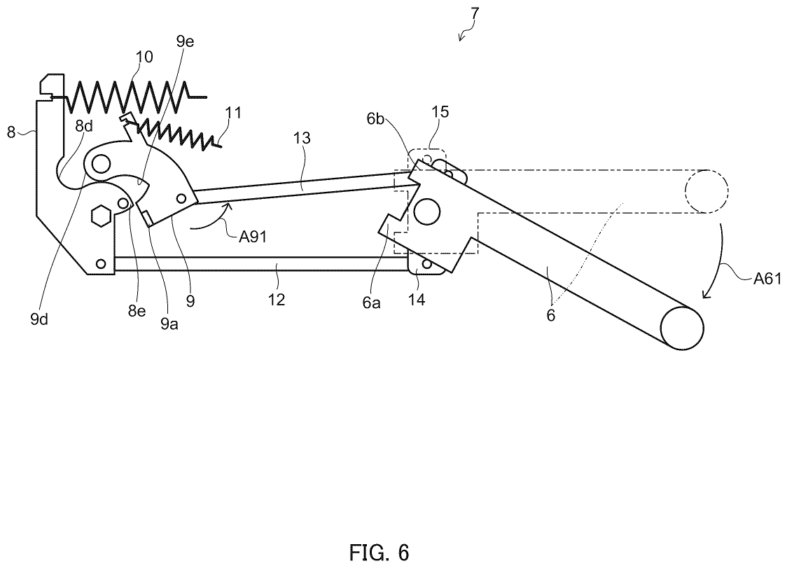

Hereinafter, a behavior for applying a brake to wheel 5 based on an operation input from a user will be described with reference to FIGS. 6 to 8. FIGS. 6 to 8 illustrate the behavior of brake mechanism 7 when brake mechanism 7 transitions from the free state to the brake state based on the operation input from the user. In the following description, in order to describe the free state of brake mechanism 7, reference may be made to FIG. 11.

The state of brake mechanism 7 illustrated in FIG. 6 corresponds to a state in which the coupling between main body 1 and cart 2 is released (that is, a non-coupled state). That is, in FIG. 6, insertion 3 is not inserted into cart 2.

In a state where lever 6 is raised (that is, a state where lever 6 is positioned at the free position), brake mechanism 7 does not apply a brake to wheel 5 (see FIG. 3), and wheel 5 is in a free state.

In the free state of wheel 5 (that is, the free state of brake mechanism 7) illustrated in FIG. 11, wheel-interlock 8 is in the reference posture, and first recess 8d of wheel-interlock 8 and first protrusion 9d of stopper 9 are separated from each other. In the free state of wheel 5 (that is, the free state of brake mechanism 7), second protrusion 8e of wheel-interlock 8 and second recess 9e of stopper 9 engage with each other.

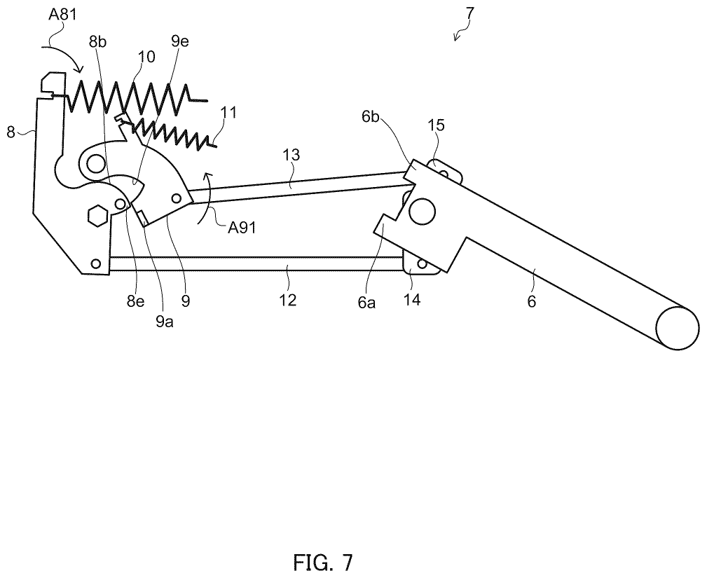

In the free state of brake mechanism 7 illustrated in FIG. 11, when the user lowers lever 6, lever 6 turns in the first rotation direction (the direction indicated by arrow A61 in FIG. 6) as illustrated in FIGS. 6 and 7. Then, stopper 9 turns in the first rotation direction (the direction indicated by arrow A91 in FIGS. 11, 6, and 7).

Specifically, when lever 6 is lowered, second claw 6b of lever 6 pushes second plate 15 rearward. Next, second plate 15 pulls second link 13 rearward. Then, second link 13 pulls stopper 9 rearward. As a result, stopper 9 turns in the first rotation direction along first outer edge 8b of wheel-interlock 8 against the biasing force of second biasing member 11.

Thus, the engagement between second protrusion 8e of wheel-interlock 8 and second recess 9e of stopper 9 is released, and wheel-interlock 8 becomes turnable. Stopper 9 turns until lever 6 is completely lowered (that is, in a state in which lever 6 is positioned at the brake position).

When wheel-interlock 8 becomes turnable, wheel-interlock 8 is pulled by first biasing member 10 and turns around the turning center in the first rotation direction (the direction indicated by arrow A81 in FIG. 7) by a predetermined angle (for example, 30 degrees), as illustrated in FIG. 7.

When wheel-interlock 8 turns by a predetermined angle, first recess 8d of wheel-interlock 8 and first protrusion 9d of stopper 9 engage with each other, as illustrated in FIG. 8. When first recess 8d of wheel-interlock 8 and first protrusion 9d of stopper 9 engage with each other, the turning of wheel-interlock 8 is stopped. Then, brake mechanism 7 enters a brake state.

As described above, when wheel-interlock 8 turns in the first rotation direction from the reference posture by a predetermined angle, hexagonal portion 5a of wheel 5 (see FIG. 4) rotates in the first rotation direction (the direction indicated by arrow A51 in FIG. 4) in accordance with the turning of wheel-interlock 8. In a state where first recess 8d of wheel-interlock 8 and first protrusion 9d of stopper 9 are engaged with each other, stopper 9 is in the second regulation posture.

As a result, a brake is applied to wheel 5. In the brake state of wheel 5 (that is, the brake state of brake mechanism 7), the turning of wheel-interlock 8 is restricted based on the engagement between first recess 8d of wheel-interlock 8 and first protrusion 9d of stopper 9. That is, the brake state of wheel 5 and brake mechanism 7 is maintained by stopper 9.

<Behavior for Releasing Brake on Wheel based on Operation Input from User>

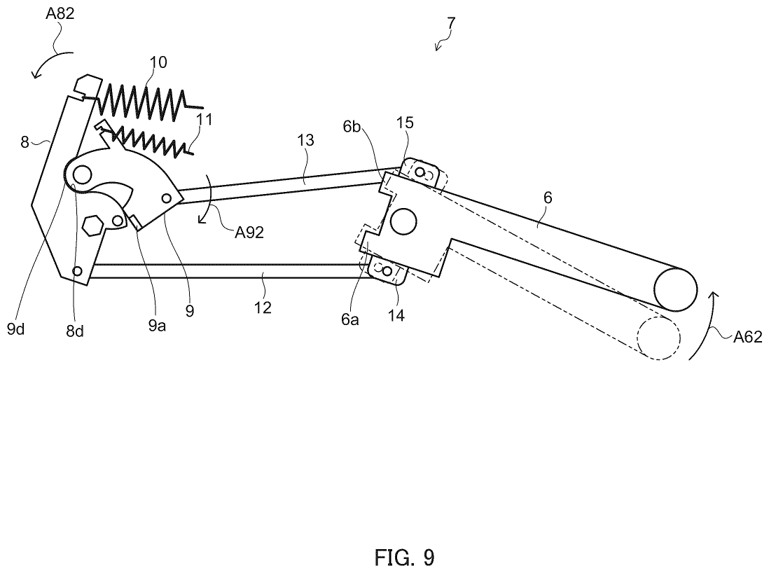

Hereinafter, a behavior for releasing the brake applied on wheel 5 based on an operation input from the user will be described with reference to FIGS. 9 to 11. FIGS. 9 to 11 illustrate the behavior of brake mechanism 7 when brake mechanism 7 transitions to the free state based on an operation input from the user.

The state of brake mechanism 7 illustrated in FIG. 9 corresponds to a state in which the coupling between main body 1 and cart 2 is released (that is, a non-coupled state). That is, in FIG. 9, insertion 3 is not inserted into cart 2.

When the brake of wheel 5 is released, the user raises, for example, lever 6 with their foot. Lever 6 turns in the second rotation direction (the direction indicated by arrow A62 in FIG. 9). When lever 6 rises, first claw 6a of lever 6 pushes first plate 14 rearward in conjunction with this turning.

Then, wheel-interlock 8 turns in the second rotation direction (the direction indicated by arrow A82 in FIG. 9) against the biasing force of first biasing member 10. Then, the engagement between first recess 8d of wheel-interlock 8 and first protrusion 9d of stopper 9 is released. As a result, wheel-interlock 8 becomes turnable.

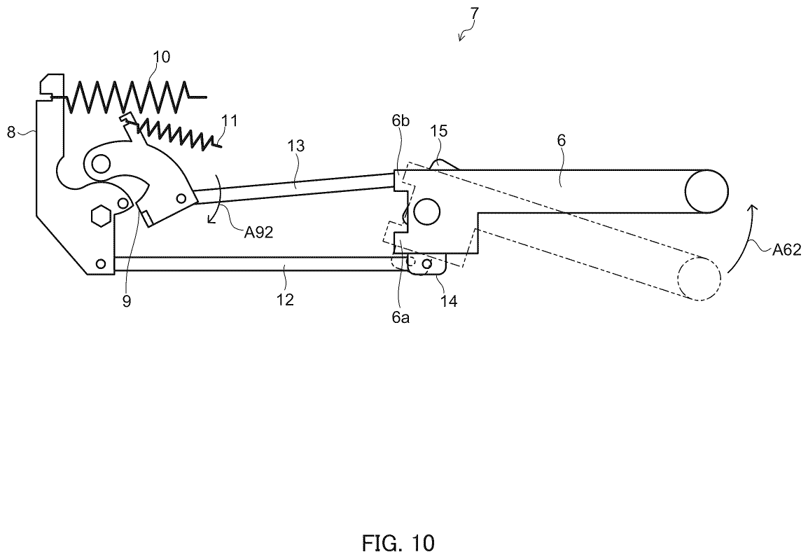

As illustrated in FIG. 10, when the user completely raises lever 6, wheel-interlock 8 is pulled by first link 12 and turns in the second rotation direction by a predetermined angle (for example, 30 degrees). At this time, wheel-interlock 8 turns against the elastic force of first biasing member 10. As a result, wheel-interlock 8 is in the reference posture illustrated in FIG. 10.

As wheel-interlock 8 approaches the reference posture, stopper 9 turns in the second rotation direction (the direction indicated by arrow A92 in FIGS. 9 and 10) based on the elastic force of second biasing member 11. Then, stopper 9 is in the posture (that is, the first regulation posture) illustrated in FIG. 11. In the state illustrated in FIG. 11, second protrusion 8e of wheel-interlock 8 and second recess 9e of stopper 9 engage with each other.

In a state where lever 6 illustrated in FIG. 11 is raised, brake mechanism 7 is in a state in which no brake is applied to wheel 5 (that is, a free state of wheel 5).

In the free state of wheel 5 (the free state of brake mechanism 7), wheel-interlock 8 is in the reference posture, and first recess 8d of wheel-interlock 8 and first protrusion 9d of stopper 9 are separated from each other. Further, in the free state of wheel 5 (the free state of brake mechanism 7), second protrusion 8e of wheel-interlock 8 and second recess 9e of stopper 9 engage with each other.

In a state where second protrusion 8e of wheel-interlock 8 and second recess 9e of stopper 9 are engaged with each other, wheel-interlock 8 is restricted from turning by stopper 9. That is, stopper 9 maintains the free state of brake mechanism 7. In a state where second protrusion 8e of wheel-interlock 8 and second recess 9e of stopper 9 are engaged with each other, stopper 9 is in the first regulation posture.

<Behavior of Brake Mechanism 7 When Main body 1 and Cart 2 are Coupled>

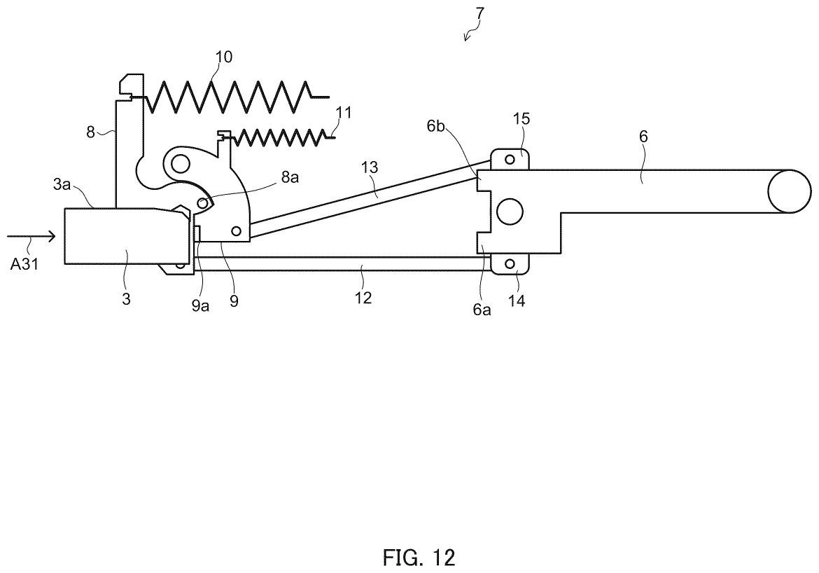

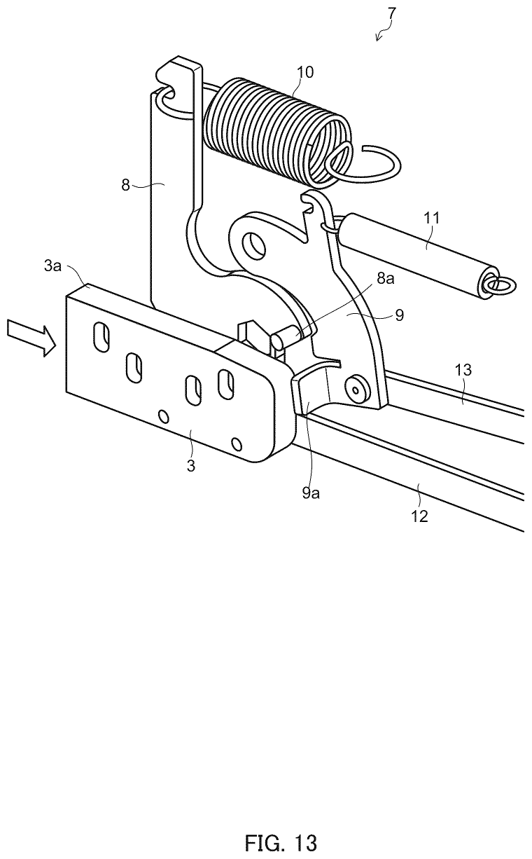

Hereinafter, the behavior of brake mechanism 7 when main body 1 and cart 2 are coupled to each other will be described with reference to FIGS. 12 to 15. FIGS. 12 to 15 illustrate the behavior of brake mechanism 7 when insertion 3 is inserted into brake mechanism 7. When main body 1 and cart 2 are coupled, brake mechanism 7 is in a free state.

After a pharmacist loads drugs onto cart 2 in a pharmacy, the pharmacist couples cart 2 to main body 1. At this time, insertion 3 moves in a predetermined direction (the direction indicated by arrow A31 in FIG. 12) and is inserted into brake mechanism 7.

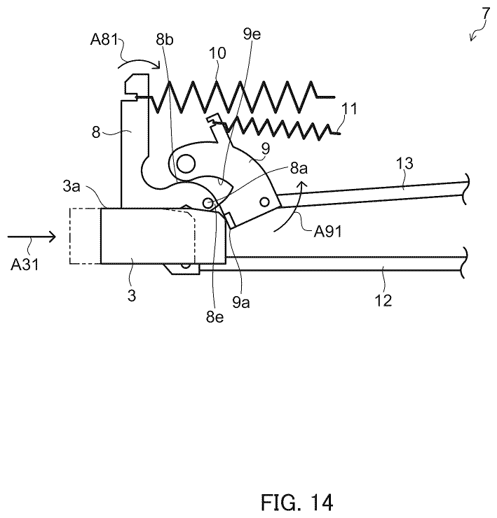

When insertion 3 is inserted into brake mechanism 7, stopper 9 is pushed by insertion 3 and slightly turns in the first rotation direction (the direction indicated by arrow A91 in FIG. 14), as illustrated in FIG. 14.

Specifically, when insertion 3 is inserted into brake mechanism 7, insertion 3 comes into contact with abutting part 9a of stopper 9. Then, insertion 3 pushes abutting part 9a of stopper 9 rearward. As a result, stopper 9 turns against the elastic force of second biasing member 11.

When stopper 9 turns, the engagement between second recess 9e of stopper 9 and second protrusion 8e of wheel-interlock 8 is released. Then, stopper 9 turns along first outer edge 8b of wheel-interlock 8 in the first rotation direction by a predetermined angle. The predetermined angle corresponds to an example of the second predetermined angle and is an angle at which no brake is applied to wheel 5. That is, the second predetermined angle is an angle at which the free state of brake mechanism 7 is maintained.

Then, stopper 9 slightly pushes second link 13 rearward. As a result, lever 6 slightly turns in the first rotation direction (the direction indicated by arrow A61 in FIG. 6) according to the turning amount of stopper 9. As a result, wheel-interlock 8 becomes turnable. In this state, brake mechanism 7 is maintained in a free state.

When the engagement between second recess 9e of stopper 9 and second protrusion 8e of wheel-interlock 8 is released, wheel-interlock 8 becomes turnable as illustrated in FIG. 14. Then, wheel-interlock 8 turns in the first rotation direction (the direction indicated by arrow A81 in FIG. 14) based on the biasing force of first biasing member 10.

Then, as illustrated in FIG. 15, contact part 8a of wheel-interlock 8 contacts side 3a of insertion 3. The rotation angle of wheel-interlock 8 in this case corresponds to an example of the first predetermined angle. The first predetermined angle is an angle at which the free state of brake mechanism 7 is maintained. In this state, the turning of wheel-interlock 8 in the first rotation direction is restricted based on the contact between contact part 8a of wheel-interlock 8 and side 3a of insertion 3.

That is, the turning of wheel-interlock 8 is restricted by insertion 3. As a result, the free state of brake mechanism 7 is maintained. In this state, brake mechanism 7 maintains the free state of brake mechanism 7 regardless of the input from the user to lever 6. In other words, lever 6 does not receive an input from the user in the state illustrated in FIG. 15.

As illustrated in FIG. 15, the turning of wheel-interlock 8 in the first rotation direction (the direction indicated by arrow A81 in FIG. 15) is restricted based on the engagement (contact) between contact part 8a of wheel-interlock 8 and insertion 3.

In other words, brake mechanism 7 is maintained in a free state, such as in a state where contact part 8a of wheel-interlock 8 and side 3a of insertion 3 are in contact with each other. At this time, first tapering part 8c of wheel-interlock 8 and second tapering part 9c of stopper 9 face each other. In the state illustrated in FIG. 15, main body 1 and cart 2 are in a coupled state.

<Behavior of Brake Mechanism 7 when Coupling between Main body 1 and Cart 2 is Released>

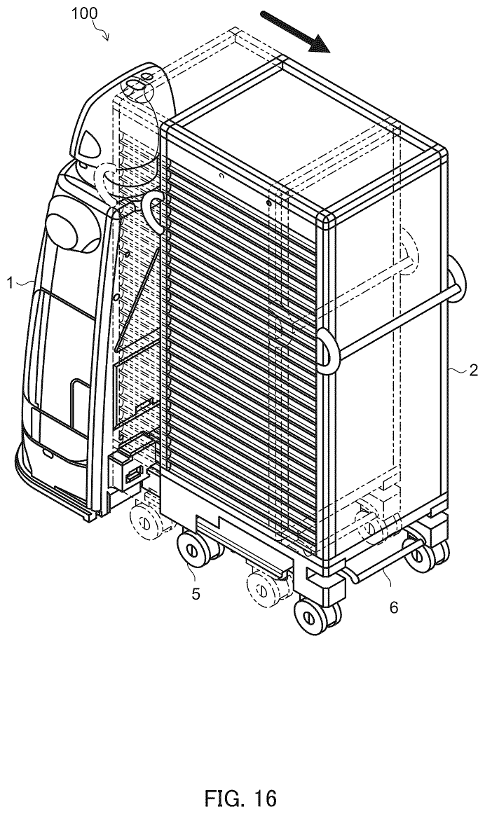

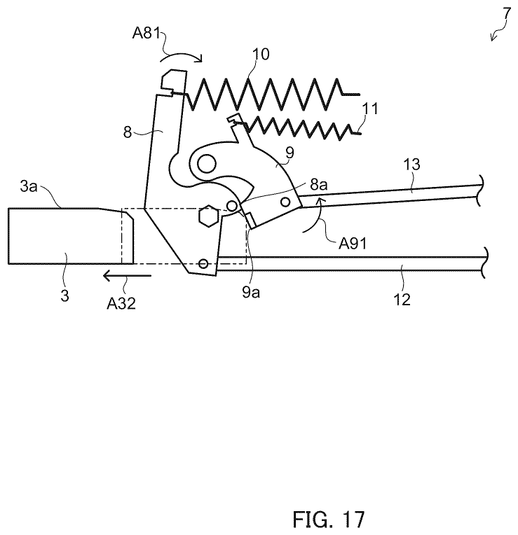

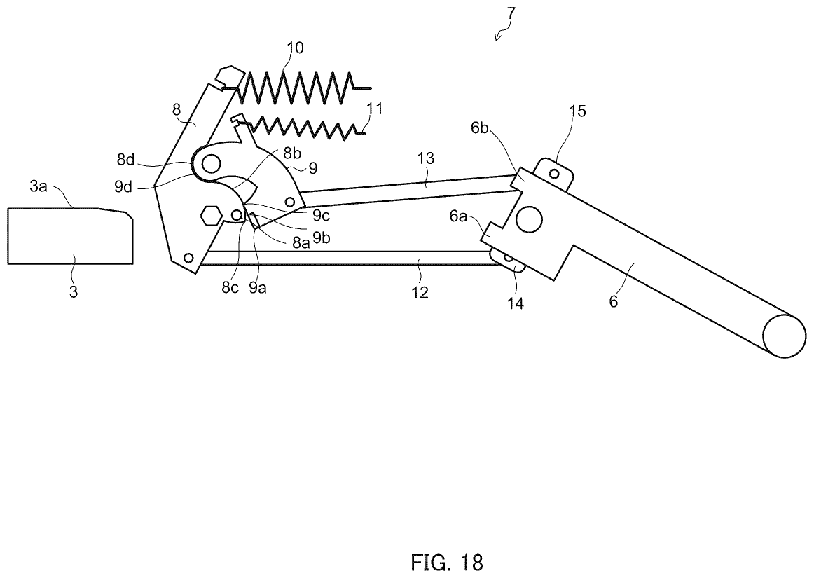

Hereinafter, the behavior of brake mechanism 7 when the coupling between main body 1 and cart 2 is released will be described with reference to FIGS. 16 to 18. FIGS. 17 and 18 illustrate the behavior of brake mechanism 7 when insertion 3 is removed from the brake mechanism. As illustrated in FIG. 16, when the coupling between main body 1 and cart 2 is released, insertion 3 is removed from brake mechanism 7.

The release of the coupling between main body 1 and cart 2 may be performed automatically or manually. Hereinafter, a method for automatically releasing the coupling between main body 1 and cart 2 will be described. During the coupled state between main body 1 and cart 2, main body 1 and cart 2 are maintained in the coupled state by a lock mechanism (not illustrated).

Robot 100 releases the lock provided by the lock mechanism under the control of controller 4 at any timing (for example, the timing of arriving at the destination). Then, in response to the release of the lock provided by the lock mechanism, stopper 9 pushes insertion 3 in the removing direction (the direction indicated by arrow A32 in FIG. 17) based on the biasing force of second biasing member 11.

As a result, insertion 3 is removed from cart 2 (brake mechanism 7), and the coupling between main body 1 and cart 2 is automatically released. That is, the coupling between main body 1 and cart 2 is automatically released. The removal of insertion 3 may be achieved by manually releasing the coupling between main body 1 and cart 2. That is, the coupling between main body 1 and cart 2 may be manually released.

When insertion 3 moves in the predetermined direction (the direction indicated by arrow A32 in FIG. 17) and is removed from brake mechanism 7, the engagement (contact) between contact part 8a of wheel-interlock 8 and insertion 3 is released, and wheel-interlock 8 becomes turnable.

Then, wheel-interlock 8 turns in the first rotation direction (the direction indicated by arrow A81 in FIG. 17) based on the biasing force of first biasing member 10. At this time, first tapering part 8c of wheel-interlock 8 moves below second tapering part 9c of stopper 9, and second protrusion 8e of wheel-interlock 8 and second tapering part 9c of stopper 9 contact each other in the front-rear direction (see FIG. 18).

Next, from the state illustrated in FIG. 17, wheel-interlock 8 turns in the first rotation direction (the direction indicated by arrow A81 in FIG. 17) by a predetermined angle (for example, 30 degrees) based on the biasing force of first biasing member 10. Then, brake mechanism 7 enters a brake state (see FIG. 18). As a result, a brake is applied to wheel 5.

Specifically, when wheel-interlock 8 turns in the first rotation direction from the state illustrated in FIG. 17, first link 12 is pulled forward by wheel-interlock 8. Next, when first link 12 is pulled forward, first plate 14 and second plate 15 (see FIG. 5) turn, and second link 13 is pulled rearward.

When stopper 9 turns in the first rotation direction (the direction indicated by arrow A91 in FIG. 17), first recess 8d of wheel-interlock 8 and first protrusion 9d of stopper 9 engage with each other (see FIG. 18). Then, wheel-interlock 8 enters a state in which turning is impossible based on the engagement between first recess 8d and first protrusion 9d. As a result, brake mechanism 7 enters a brake state.

The brake state of brake mechanism 7 is maintained based on the engagement between first recess 8d and first protrusion 9d (in other words, by stopper 9). When wheel-interlock 8 turns in the first rotation direction from the state illustrated in FIG. 17, lever 6 is lowered along with the turning of first plate 14.

In other words, when wheel-interlock 8 turns in the first rotation direction from the state illustrated in FIG. 17, lever 6 moves from the free position to the brake position (the position of lever 6 illustrated in FIG. 18).

When the coupling between main body 1 and cart 2 is released, robot 100 according to the present embodiment having the configuration described above automatically transitions brake mechanism 7 from the free state to the brake state. Therefore the present disclosure can provide robot 100 capable of applying a brake to cart 2 during a state where the coupling between main body 1 and cart 2 is released. The actions and effects of robot 100 according to the present embodiment are as described above.

### <Appendix>

The embodiments described above are no more than specific examples in carrying out the technology according to the present disclosure, and the technical scope of the technology according to the present disclosure is not to be construed in a limitative sense due to the specific examples. That is, the technology according to the present disclosure can be implemented in various forms without departing from the main features.

The disclosure of Japanese Patent Application No. 2022-161940, filed on Oct. 6, 2022, including the specification, drawings and abstract, is incorporated herein by reference in its entirety.

### INDUSTRIAL APPLICABILITY

The present disclosure is useful for a robot capable of applying or releasing a brake on a cart.

### REFERENCE SIGNS LIST

1 Main body
2 Cart
3 Insertion
3a Side
4 Controller
5 Wheel
5A Front wheel
5B Rear wheel
5a Hexagonal portion
6 Lever
6a First claw
6b Second claw
7 Brake mechanism
8 Wheel-interlock
8a Contact part
8b First outer edge
8c First tapering part
8d First recess
8e Second protrusion
9 Stopper
9a Abutting part
9b Second outer edge
9c Second tapering part
9d First protrusion
9e Second recess
10 First biasing member
11 Second biasing member
12 First link
13 Second link
14 First plate
15 Second plate
100 Robot

1. 1 A robot comprising:
a main body; and
a cart that includes a wheel and is capable of coupling to the main body,
wherein
the main body includes an insertion that is inserted into the cart when the main body is in a coupled state with the cart,
the cart includes a brake mechanism that switches between a brake state in which a brake is applied to the wheel and a free state in which the brake is not applied to the wheel, and
in the brake mechanism,
during the coupled state, the free state is maintained by the insertion, and
when the coupled state is released and the insertion is removed from the cart, the free state is switched to the brake state.

2. The robot according to claim 1, wherein:
the brake mechanism includes
a wheel-interlock that is connected to the wheel and turns between a first posture corresponding to the free state and a second posture corresponding to the brake state, and
a stopper that provides a restriction on turning of the wheel-interlock based on a disposition relationship between the stopper and the wheel-interlock;
during the coupled state, the free state is maintained by reaching a state in which the restriction by the stopper on the turning of the wheel-interlock is released by the insertion and a state in which the turning of the wheel-interlock is restricted by the insertion; and
when the insertion is removed from the cart, the wheel-interlock turns from the first posture toward the second posture, and the free state is switched to the brake state.

3. The robot according to claim 2, wherein
in the first posture and the second posture, the turning of the wheel-interlock is restricted by the stopper.

4. The robot according to claim 3, wherein
during the coupled state, the turning of the wheel-interlock is restricted by the insertion in a state in which the wheel-interlock has turned by a first predetermined angle from the first posture toward the second posture.

5. The robot according to claim 4, wherein
the first predetermined angle is an angle at which the free state of the brake mechanism is maintained.

6. The robot according to claim 2, wherein:
the stopper is configured to be turnable between a first regulation posture and a second regulation posture;
in the first regulation posture, the stopper maintains the free state based on the disposition relationship between the stopper and the wheel-interlock in the first posture; and
in the second regulation posture, the stopper maintains the brake state based on the disposition relationship between the stopper and the wheel-interlock in the second posture.

7. The robot according to claim 6, wherein
during the coupled state, turning of the stopper is restricted by the insertion in a state in which the stopper has turned by a second predetermined angle from the first regulation posture toward the second regulation posture.

8. The robot according to claim 7, wherein
the second predetermined angle is an angle at which the free state of the brake mechanism is maintained.

9. The robot according to claim 6, wherein
the brake mechanism includes
a first biasing member that constantly biases the wheel-interlock in a direction in which the wheel-interlock turns from the first posture to the second posture, and
a second biasing member that constantly biases the stopper in a direction in which the stopper turns from the second regulation posture to the first regulation posture.

10. The robot according to claim 6, wherein
the cart includes an operation input that changes a posture of the stopper based on an input from a user, the operation input being connected to the brake mechanism.

11. The robot according to claim 10, wherein:
during a non-coupled state in which the coupling between the main body and the cart is released, the operation input changes the posture of the stopper based on the input from the user; and
during the coupled state, the operation input does not change the posture of the stopper even when the operation input receives the input from the user.

12. The robot according to claim 10, wherein:
the operation input is configured to, based on the input from the user, switch between a brake position corresponding to the brake state and a free position corresponding to the free state; and
when the operation input turns from the free position to the brake position, the operation input turns the stopper from the first regulation posture to the second regulation posture; and
when the operation input turns from the brake position to the free position, the operation input turns the wheel-interlock from the second posture to the first posture.
